(19) United States
(12) Patent Application Publication
(10) Pub. No.: US 2008/0086864 A1
(43) Pub. Date: Apr. 17, 2008

(54) System and method for component mounting

(76) Inventors: Roman Michael Wajda, Greer, SC (US); Donald L. Nisley, Greenville, SC (US); William Tucker Woodson, Pelzer, SC (US); Rich F. Schiferl, Chagrin Falls, OH (US)

Correspondence Address: ROCKWELL AUTOMATION, INC./(FY), ATTENTION: SUSAN M. DONAHUE, E-7F19, 1201 SOUTH SECOND STREET, MILWAUKEE, WI, 53204, US

(21) Appl. No.: 11/540,378

(22) Filed: Sep. 29, 2006

(51) Int. Cl. B21D 39/03; B23P 11/00

(52) U.S. Cl. 29/434; 29/428; 29/525.01

(57) ABSTRACT

A method for coupling first and second mechanical members is provided. In one embodiment, the method includes providing at least one insulating sleeve and a mating locking member. The locking member may be configured to cooperate with the at least one insulating sleeve to secure the first and second mechanical members to one another. Additionally, the at least one insulating sleeve may facilitate electrical isolation of the first and second members. Various additional component mounting systems, methods, and locking members are also provided.

### BACKGROUND

The invention relates generally to the field of rotating machinery. More particularly, the present techniques regard arrangements for securing a component of such machinery, such as a shaft or bearing, within a hollow support member.

A wide range of rotating machinery is known and currently in use in a variety of industrial, commercial, and other applications. In many such applications shafts (or inner hubs) are supported for rotation within hollow members, such as outer or mounting hubs, and other mechanical supports. The shaft may be driven in rotation by a prime mover, such as an electric motor or engine, or may be linked to various power transmission elements such as chain drives, belt drives, transmissions, pulleys, and so forth. In all such applications mounting structures are typically required to support the rotating and non-rotating members with respect to one another in a manner sufficient to resist loading, while still permitting free rotation of the rotating members.

When mounting rotating elements on or within other components, several key considerations generally come into play. For example, the bearing, hub, or other associated coupling or mounting structures must be capable of withstanding the anticipated loads of the application. Moreover, the mounting structures should allow for the desired balancing or centering of loads within or about the bearing assemblies and hub configurations. Also, the mounting arrangements should prevent premature wear or fretting of the shaft, bearing, or other mounting components, and thus provide for a maximum life in normal use. The arrangements should also permit use of hollow members having non-tapered (i.e., cylindrical inner diameters or bores) if desired to permit use, for example, of lower-cost and standard off-the-shelf bearing assemblies and mounting hubs. It may also be desirable to reduce or prevent any current present in a shaft, such as that induced by a variable frequency drive, from passing to ground through a bearing assembly or other component to which the shaft is mounted. Finally, the mounting structures would ideally be relatively straightforward in application, permitting the shaft (or inner hub) with bearing assemblies or outer hub configurations to be installed without undue expense, both in terms of time and parts. The latter concern extends to dismounting or disassembling the various components for servicing and replacement when necessary, resulting in less downtime and higher productivity.

Mounting structures and techniques have been developed that partially address these concerns, although further improvement is necessary. For example, various components may be constructed with an interference fit that secures and centers components with respect to one another. Further, various tapered locking structures have been developed that force tapered members between a shaft and a mounting hub or bearing. A wide range of structures have been developed for forcing one or more tapered sleeves, for example, into engagement between a hollow member and an inner component, such as a shaft. Such structures provide good mechanical support and allow for tight engagement of the hollow member and inner component. However, disassembly of such structures is often problematic, sometimes resulting in damage or destruction of mechanical components of the system, such as a shaft or tapered sleeve, for example. In certain known arrangements, the mounting components are also relatively expensive to manufacture and can be difficult to assemble and disassemble.

There is a need, therefore, for an improved system for mounting a machine component, such as a shaft, bearing, or similar mechanical component within a hollow member or recess. There is a particular need for a straightforward and reliable system for mounting rotating elements, such as shafts or bearings, within hollow members.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The present invention provides a novel technique for supporting a rotating member with respect to a non-rotating member designed to respond to such needs. While the system is described herein as applied to a hollow member in which a shaft is mounted, the invention extends to mounting of shafts, hubs, bearings, and other mechanical elements as well. Similarly, the presently disclosed techniques are particularly well suited to mounting of shafts, hubs, or other rotating elements within bearing assemblies or mounting hub configurations, and to mounting of bearing assemblies or other elements within a hollow member or recess. The present techniques may also find application in the mounting of stationary members centrally, with a bearing or other rotating or non-rotating element about the central member.

In certain embodiments, a mounting system includes a tapered locking arrangement in which a tapered surface of a sleeve interfaces with a mating tapered surface of an additional component, such as a bearing component or other sleeve, to allow various mechanical components to enter into tight engagement during assembly. A locking member or nut is secured to the tapered sleeve to draw the tapered sleeve into tight engagement between a hollow member in which the sleeve is disposed, and one or more inner mechanical members, such as a bearing, shaft, sleeve, or the like. In one embodiment, the nut is configured to be disposed within the sleeve and includes an eccentric flange or lip and varying depth groove that interface with the certain features of the sleeve. Engagement of the nut on a threaded portion of the tapered sleeve centers the nut and allows the nut to be tightened to draw the assembly into tight engagement. For disassembly, the nut is rotated in an opposite direction to force the sleeve out of engagement, freeing the various components from one another. In a further embodiment, at least one sleeve of the assembly is non-conductive and aids in electrically isolating components disposed inside the sleeve from those disposed outside of the sleeve.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### DRAWINGS

The foregoing and other advantages of the invention will become apparent upon reading the following detailed description and upon reference to the drawings in which:

FIG. 1 is a perspective view of a mounting system in accordance with aspects of the present technique, illustrated as installed between a bearing and shaft in accordance with one embodiment of the present invention;

FIG. 2 is a partial sectionaI view of the system of FIG. 1, illustrating the engagement of the various components with respect to one another in accordance with one embodiment of the present invention;

FIG. 3 is an elevational view of a locking member or nut as used in the system of FIG. 2, illustrating the eccentric aperture and varying depth groove used for mounting and operating the nut for engagement and disengagement of the system;

FIG. 4 is a side sectional view of the nut as shown in FIG. 3, illustrating various surfaces and features of the nut;

FIG. 5 is a detail view of interfacing surfaces of the nut and hollow member as illustrated in FIG. 2;

FIG. 6 is a sectional view of a mounting system in accordance with aspects of the present technique, illustrated as installed between a shaft and an outer member having a cylindrical inner surface in accordance with one embodiment of the present invention;

FIG. 7 is a sectional view of the tapered outer sleeve as shown in FIG. 6, illustrating various surfaces and features of the tapered outer sleeve;

FIG. 8 is a detail view of various surfaces and lips of the tapered outer sleeve which engage the nut and outer member as illustrated in FIG. 6;

FIG. 9 is a sectional view of the exemplary tapered inner sleeve used in both of the mounting systems illustrated in FIGS. 2 and 6;

FIG. 10 is a partial sectional view of a motor including components secured therein in accordance with one embodiment of the present invention.

FIG. 11 is a partial sectional view of a bearing assembly installed within an end cap of the motor of FIG. 10 in accordance with one embodiment of the present invention;

FIG. 12 is an elevational view of an exemplary locking member or nut as used in the system of FIG. 1, illustrating the eccentric flange or lip and varying depth groove used for mounting and operating the nut for engagement and disengagement of the system;

FIG. 13 is a side sectional view of the nut as shown in FIG. 12, illustrating various surfaces and features of the nut; and

FIG. 14 is a detail view of interfacing surfaces of the nut and sleeves as illustrated in FIG. 11.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “he,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

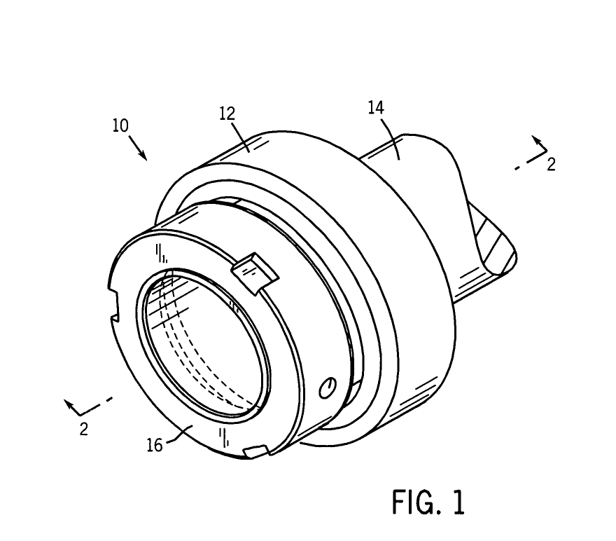

Turning now to the drawings, and referring first to FIG. 1, an exemplary mounting system 10 is illustrated for securing a mechanical member within a hollow member. In the application illustrated in FIG. 1, the hollow member is part of a bearing assembly 12 secured on a shaft 14. As will be appreciated by those skilled in the art, many such applications exist, typically for rotating machinery and power transmission applications. As noted above, it should be borne in mind that the system described herein may be applied in various settings, including for rotating and non-rotating applications. Moreover, while a shaft is shown and described herein, various types of mechanical elements may be employed with the present system, such as hubs, various support extensions, gearing, pinions, bearings, and so forth. Similarly, while as described herein bearing 12 supports shaft 14 in rotation, in other applications, the central member, such as shaft 14 may be stationary with the bearing supporting other elements in rotation, such as in pulleys, conveyers and the like. As described in greater detail below, a nut 16 of system 10 serves to tightly engage the bearing assembly 12 and shaft 14 with respect to one another, while permitting straightforward assembly and disassembly of the system with minimal strain and unwanted loading to the bearing, shaft, and associated components.

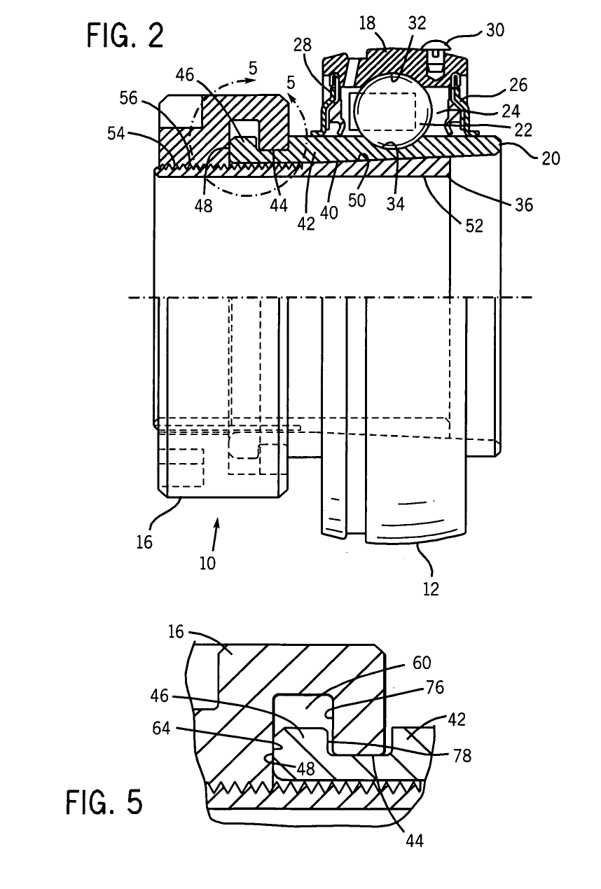

System 10 is illustrated in greater detail in FIG. 2. As shown in FIG. 2, in the exemplary embodiment illustrated the system is applied to a bearing assembly 12 consisting of an outer ring 18, an inner ring 20, and bearing elements 22 disposed therebetween. Outer ring 18 and inner ring 20 bound an inner volume 24 in which the bearing elements 22 are disposed. Where desired, lubricants, such as grease can be provided within the inner volume and retained by seal assemblies 26 and 28 on either side of the bearing assembly. Various other components and elements may be provided in a typical bearing assembly, such as an anti-rotation pin 30. As will be appreciated by those skilled in the art, bearing assembly 12 would typically be mounted within one of a variety of housing styles depending upon the mechanical configuration of the application, the anticipated loading, and so forth.

The particular configurations of the inner and outer rings of the bearing assembly facilitate operation of the bearing assembly and its interfacing with mounting structures. In the illustrated embodiment, outer ring 18 forms an outer race 32, while inner ring 20 forms and inner race 34 on which the bearing elements 22 bear. As described in greater detail below, for the present purposes, inner ring 34 serves as a hollow member in which the shaft (shown in FIG. 1) is mounted. A tapered sleeve 36 is fitted within the inner ring 20. To interface with the tapered sleeve 36, inner ring 20 has a tapered inner surface 40 inclined in a converging direction from right to left in the embodiment illustrated in FIG. 2. An extension 42 of the inner ring includes an outer annular groove 44 bounded by an annular lip 46. Lip 46 lies adjacent to a distal or end face 48 of the inner ring, which in a present embodiment serves as an abutment face during assembly of the various components.

Tapered sleeve 36 presents a tapered outer surface 50 designed to engage tapered inner surface 40 of inner ring 20. The inner surface 52 of the tapered sleeve 36 has a configuration designed to interface with the shaft in application, such as a generally right cylindrical shape in the embodiment shown in FIG. 2. It should be noted that various additional features not specifically illustrated in the figures may be included within the sleeve. For example, slits extending partially or completely through the sleeve may be provided to permit expansion or contraction of the sleeve during tightening or untightening within the assembly. Similarly, such slits may accommodate keys, splines, or other mechanical features used to secure the various elements with respect to one another and to permit transmission of torque in application. The tapered sleeve 36 further includes an externally threaded extension 54 designed to interface with nut 16 as described below. Additionally, as also described below, the tapered sleeve 36 may be a non-conductive sleeve that electrically isolates the bearing assembly 12 from the shaft 14.

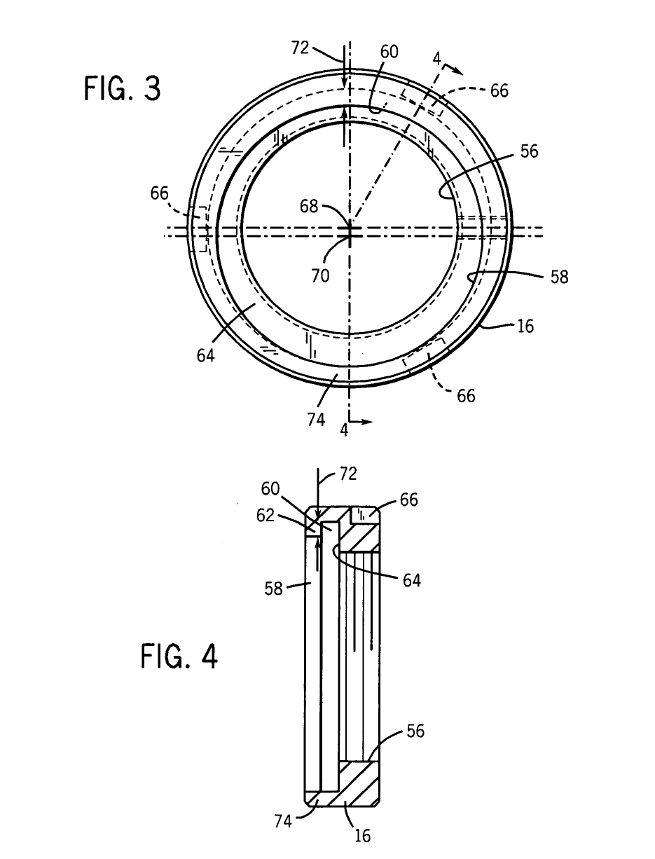

As best illustrated in FIGS. 2, 3 and 4, nut 16 has a threaded inner surface 56 designed to engage the threaded extension 54 of sleeve 36. An aperture 58 (see, e.g., FIGS. 3 and 4) is formed eccentrically on a front face of nut 16. The aperture forms an opening larger than the diametrical dimension of lip 46 of inner ring 20, such that the nut may be slipped onto the lip 46 during assembly. An internal groove 60 is formed within nut 16 so as to form a radially inwardly projecting lip 62 between the groove 60 and the eccentric aperture 58. Groove 60 is concentric with respect to the general configuration of the nut, and particularly with respect to the threaded inner surface 56. Owing to the concentricity of the groove 60 and the eccentricity of aperture 58, a lip 62 is formed which, like groove 60, has a depth which varies circumferentially around the nut. Groove 60 is bounded on a side opposite lip 62 by an abutment face 64. Finally, tool recesses 66 or similar structures are preferably provided to permit engagement of a tool (not shown) for tightening and loosening the nut in the assembly.

Referring to FIGS. 3 and 4, the threaded inner surface 56 of nut 16, and groove 60, share a central axis 68, which is generally the rotational axis of nut 16. Eccentric aperture 58, on the other hand, has an axis 70 that is displaced from axis 68 so as to form the groove and lip of varying depth. In the illustrated embodiment, the groove 60 and lip 62 have a depth that varies from a maximum depth 72 to a minimal depth 74 at a point diametrically opposed to depth 72. In the illustrated embodiment, at the point of minimum depth 74, the groove 60 is substantially flush with eccentric aperture 58. Various other configurations can, of course, be provided at which the minimum depth does not vary down to the point at which the groove and aperture are flush with one another. As noted above, and referring again to FIG. 2, the illustrated configuration of nut 16 permits the nut to be installed on the inner ring 20 and engaged on the threaded extension 54 of sleeve 36. In particular, because the eccentric aperture 58 is larger in dimension than the lip 46 of the inner ring 20, with the bearing assembly, shaft and tapered sleeve positioned loosely with respect to one another, the nut can be placed over the lip 46 and centered on the tapered sleeve. The tapered sleeve is then drawn outwardly into engagement with the nut, and the nut is threaded onto the sleeve to draw the sleeve into tight engagement between the inner ring 20 and the shaft.

Interaction of various surfaces of the nut and inner ring 20 are best illustrated in FIG. 5. As shown in FIG. 5, as nut 16 is rotated during assembly of the system, abutment face 64 of the nut contacts the distal face 48 of the inner ring to maintain the inner ring generally in its position, while drawing the sleeve into tight engagement between the inner ring and the shaft (see, e.g., FIG. 2). In an alternative embodiment, the lip formed on the nut can be engaged on a corresponding surface of the inner ring. However, in the present embodiment, full engagement of the distal face of the inner ring and the abutment face of the nut is preferred to force tight engagement of the sleeve within the inner ring.

Disassembly of the tapered sleeve from the inner ring is effected by counterrotation of the nut. In the detail view illustrated in FIG. 5, the outer surface 76 of the varying depth lip formed on the nut engages an inner surface 78 of lip 46 of the inner ring. Although the two surfaces do not engage fully over 360°, it has been found that excellent force distribution can be obtained to cause release of the tapered sleeve from the shaft and inner ring. Again, the nut is maintained centered by engagement on the threaded extension 54 of the sleeve. Following the initial release of the sleeve and inner ring, the system can be fully disassembled by disengagement of the nut from the tapered sleeve, and removal of the inner ring, tapered sleeve, and shaft from one another.

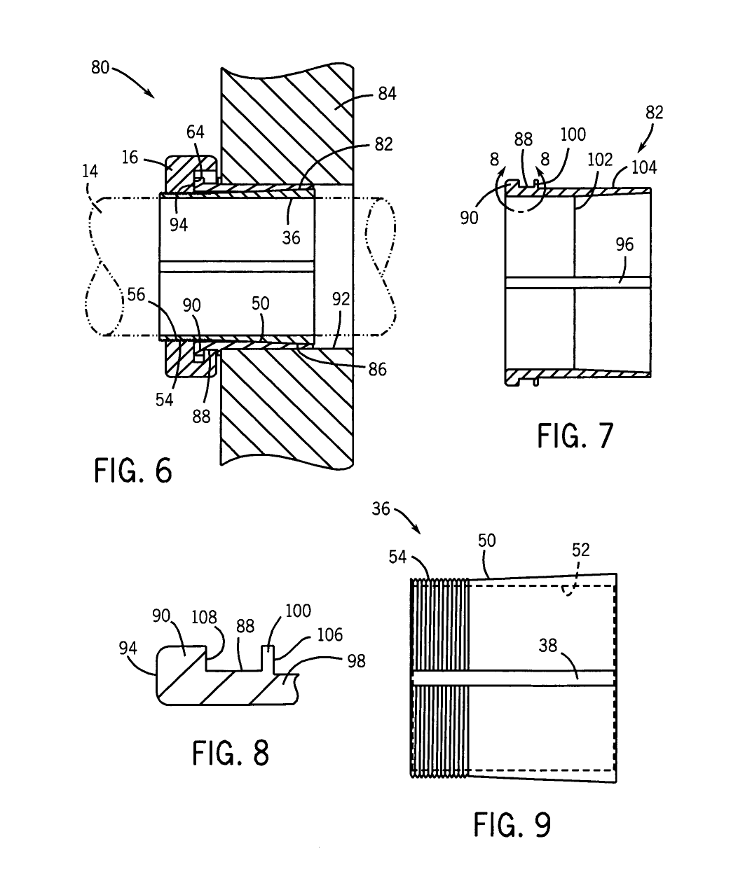

Referring to FIG. 6, an exemplary mounting system 80 is illustrated generally for securing a mechanical member within a hollow member. System 80 employs two tapered sleeves 36 and 82 in contrast to system 10 where a single tapered sleeve 36 is used. Thus, as explained below, a hollow member having a non-tapered inner surface may be used, which may allow, for example, use of hollow members that are less expensive and more readily available. To permit use of a non-tapered hollow member, an interface is formed between the tapered surfaces of each sleeve 36 and 82. This leaves the non-tapered inner surface 52 of the inner sleeve 36 to mount against the shaft 14, as in system 10 (see FIGS. 1-5 and associated text), and the non-tapered surface of the outer sleeve 82 to mount against the non-tapered (i.e., cylindrical) inner surface of the hollow member. Thus, again, the hollow member of system 80 need not have a tapered inner surface, but may have a cylindrical bore, for example.

In general, in the application illustrated in FIG. 6, the hollow member is an outer member 84, such as a mounting hub, fan hub, sheave hub, bearing assembly, and so forth, secured on a shaft 14. As similarly discussed above for system 10, many such applications may exist, for example, in rotating machinery, power transmission, and non-rotating applications. In this example, the outer member 84 supports the shaft 14 in rotation. Moreover, while a shaft is shown and described herein, various types of mechanical elements may be employed with the present system, such as inner hubs, various support extensions, gearing, pinions, and so forth. Also, as will be appreciated by those skilled in the art, outer member 84 may be mounted within one of a variety of housing styles depending upon the mechanical configuration of the application, the anticipated loading, and so forth. The particular configurations of the outer member 84 facilitate its operation and interfacing with mounting structures.

As for the interface of tapered surfaces of mounting system 80, the tapered inner surface 86 of the outer sleeve 82 is inclined in a converging direction from right to left in the embodiment illustrated in FIG. 6, and the inner sleeve 36 presents a tapered outer surface 50 designed to engage the tapered inner surface 86 of the outer sleeve 82. Further, the nut 16 of system 10 is utilized in system 80, and similarly secures the outer member 84 and shaft 14 with respect to one another, while permitting straightforward assembly and disassembly of the system with minimal strain and unwanted loading to the bearing, shaft, and associated components. An outer annular groove 88 and first lip 90 of the tapered outer sleeve 82 engage the nut 16. Additionally, as explained above for system 10, the tapered inner sleeve 36 includes an externally threaded extension 54 designed to interface with nut 16 (see also FIGS. 2 and 5 and associated text).

As the nut 16 is rotated (i.e., via tool recesses 66 shown in FIGS. 3 and 4) and tightened to lock the assembly, the outer surface of the tapered outer sleeve 82 tightly engages the inner surface 92 (bore) of the shaft 14. A distal or end face 94 of the tapered outer sleeve 82, which lies adjacent to the lip 90, serves as an abutment face during assembly of the various components. More detail of the tapered outer sleeve 82 is illustrated in FIGS. 7 and 8.

In the illustrated example of FIG. 7, one or more slits 96 extend through the outer sleeve 82 to permit expansion or contraction of the outer sleeve 82 during tightening or untightening within the assembly. The outer annular groove 88 (bounded by the first lip 90) is contained on an extension 98 of the outer sleeve 82. The extension 98 also comprises a second lip 100 that prevents movement of the nut 16 into the outer member 84. Also shown in FIG. 7 is the point of the taper start 102 of the outer sleeve 82. As previously indicated, for the tapered (inner) surface 86 of the outer sleeve, the exemplary taper diverges from left to right (see also FIG. 6). Also as discussed, the outer surface 104 of the outer sleeve 82 engages the cylindrical inner surface 92 of the outer member 84.

FIG. 8 provides an expanded view of the extension 98 having surfaces involved in the tightening and loosening of the nut 16 in mounting system 80. When tightening the nut, the nut is rotated and the abutment face 64 (see FIG. 6) of the nut 16 bears against the distal face 94 of the outer sleeve 82 to draw inner sleeve 36 into the outer sleeve 82. Further, as indicated with the second lip 100 mentioned above, a stop face 106 prevents the outer sleeve 82 from penetrating into the outer member 84. To loosen and remove the nut 16, the nut 16 is counter rotated and the lip 62 (see FIG. 4) bears against lip face 108 (on the first lip 90 of the outer sleeve 82) to resist force of the threads 54 and 56 pushing the inner sleeve 36 out of the outer sleeve 82. It should be noted that the nut 16 arrangement with outer sleeve 82 of system 80 shares some similarity to that with the inner ring 20 of system 10.

For example, the configuration of nut 16 permits the nut to be installed on the outer sleeve 82 (as with the inner ring 20) and engaged on the threaded extension 54 of the inner sleeve 36. This is possible, in part, because the eccentric aperture 58 is larger in dimension than the lip 90 of the outer sleeve 82. Further, with the outer member 84, shaft, and inner and outer sleeves positioned loosely with respect to one another, the nut can be placed over the lip 90 and centered on the inner sleeve. The inner sleeve is then drawn outwardly into engagement with the nut, and the nut is threaded onto the inner sleeve to draw the inner sleeve into tight engagement between the outer sleeve and the shaft.

Disassembly of the inner sleeve from the outer sleeve is effected by counterrotation of the nut. The outer surface 76 of the varying depth lip formed on the nut engages an inner surface 78 of first lip 90 of the outer sleeve 82 to cause release of the inner sleeve from the shaft and outer sleeve. As in system 10, the nut is maintained centered by engagement on the threaded extension 54 of the inner sleeve. Following the initial release of the inner and outer sleeves, the system 80 can be fully disassembled by disengagement of the nut from the inner sleeve, and removal of the inner and outer sleeves, shaft, and outer member from one another.

FIG. 9 illustrates the tapered inner sleeve 36 that may be used in both of the mounting systems 10 and 80 illustrated in FIGS. 1 and 6, respectively. The inner surface 52 of the tapered (inner) sleeve 36 has a configuration designed to interface with the shaft in application, such as a generally right cylindrical shape in the embodiment shown in FIG. 6. As with system 10, various additional features not specifically illustrated in the figures may be included within the inner sleeve 36 in mounting system 80. For example, keys, splines, or other mechanical features used to secure the various elements with respect to one another and to permit transmission of torque in application. As discussed, the externally threaded extension 54 of the inner sleeve 36 engages the threaded inner surface (see FIG. 2) of the nut 16. (In one example, a set screw in the nut is loosened prior to rotating the nut on the inner sleeve). Also, the tapered outer surface 50 engages the inner surface 92 (see FIG. 6) of the outer member 84. Finally, the inner surface 52 engages the shaft 14.

In one embodiment, in addition to securing two mechanical components to one another, the presently disclosed sleeves 36 and 82 (as well as sleeves 162 and 164 discussed below) may also facilitate repair and reuse of a damaged component. For instance, if the surface of the shaft 14 or an inner surface of outer member 84 is damaged, material from the damaged surface may be removed, such as by machining or turning down the damaged surface. While this process may alter the geometry of the component (e.g., the diameter), mounting or adapter sleeves having an increased thickness may be employed in place of the removed material. The shaft 14 may then be mounted in accordance with the presently disclosed techniques, thus avoiding the time and expense of either replacing or rebuilding the damaged surface. In an alternative embodiment, other components, such as a bearing component, may be similarly repaired and installed in full accordance with the present techniques.

It will be appreciated that in certain applications, such as in a system employing a variable frequency drive, a current may be induced across the shaft 14. If left unprotected, this shaft current may pass through a bearing assembly and housing to ground. Such current may result in pernicious arcing within the bearing assembly, increasing the likelihood of damage and decreasing the operating life of the bearing assembly. In order to reduce these effects, in certain embodiments, one or both of the sleeves 36 and 82 may be designed to be non-conductive. In one embodiment, the non-conductive sleeve(s) may be formed of a non-conductive material, such as a plastic. In another embodiment, the non-conductive sleeve(s) may include a non-conductive coating formed on the sleeve, in which case the underlying material may be either a conductive or non-conductive material. In the presently illustrated embodiment, the non-conductive sleeve(s) 36 and/or 82 are interposed between the shaft 14 and the outer member 84, which may be the inner ring of a bearing assembly, to electrically isolate the shaft 14 from the outer member 84. As discussed in greater detail below, one or more non-conductive sleeves may also or instead be interposed between the outer circumference of a bearing assembly and a bearing support surface or housing to facilitate electrical isolation of the bearing assembly from the housing, disrupting the electrical path from the shaft to ground through the bearing assembly.

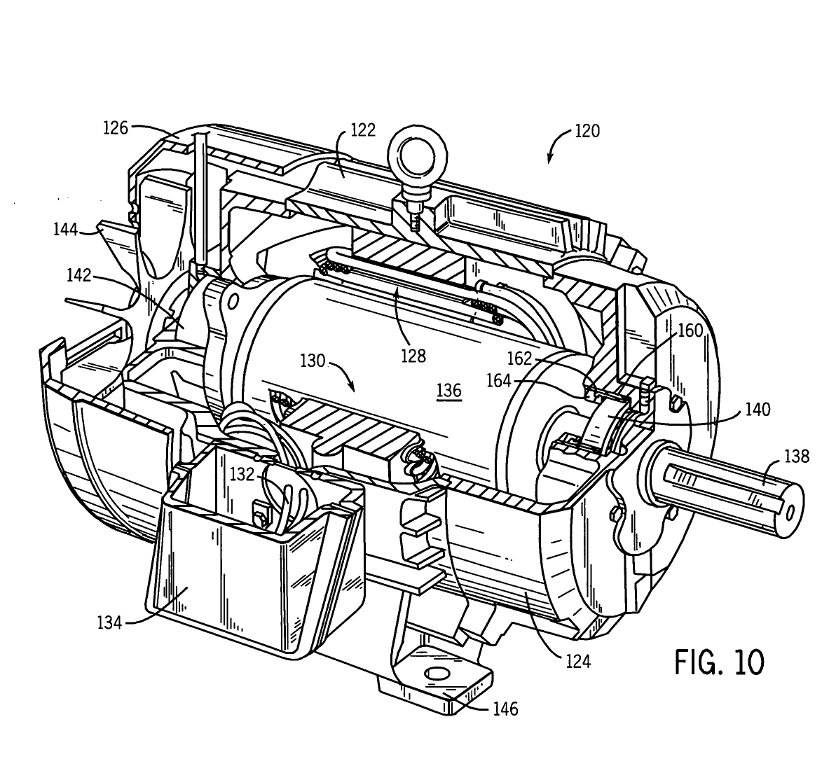

In some applications, it may be desirable to secure various components, such as a shaft and/or bearing assemblies within a rotating machine, such as the exemplary electric motor illustrated in FIG. 10 and designated generally by the reference numeral 120. In the embodiment illustrated in FIG. 10, motor 120 is an induction motor housed in an enclosure. Accordingly, motor 120 includes a frame 122 open at front and rear ends and capped by a front end cap 124 and a rear end cap 126. The frame 122, front end cap 124, and rear end cap 126 form a protective shell, or housing, for a stator assembly 128 and a rotor assembly 130. Stator windings are electrically interconnected to form groups, and the groups are, in turn, interconnected. The windings are further coupled to terminal leads 132. The terminal leads 132 are used to electrically connect the stator windings to an external power cable (not shown) coupled to a source of electrical power. Energizing the stator windings produces a magnetic field that induces rotation of the rotor assembly 130. The electrical connection between the terminal leads and the power cable is housed within a conduit box 134.

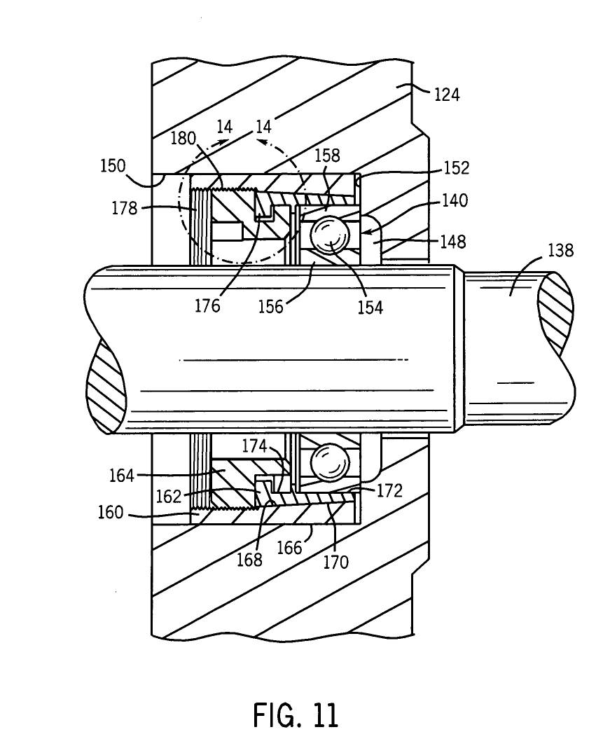

In the embodiment illustrated, rotor assembly 130 comprises a rotor 136 supported on a rotary shaft 138. As will be appreciated by those skilled in the art, shaft 138 is configured for coupling to a driven machine element (not shown), for transmitting torque to the machine element. Rotor 136 and shaft 138 are supported for rotation within frame 122 by a front bearing set 140 and a rear bearing set 142 mounted within front end cap 124 and rear end cap 126, respectively. As discussed in greater detail below with respect to FIGS. 11-14, the bearing sets in one embodiment may be secured within the front and rear end caps via sleeves 160 and 162 in cooperation with a locking member 164. In the illustrated embodiment of electric motor 120, a cooling fan 144 is supported for rotation on shaft 138 to promote convective heat transfer through the frame 122. The frame 122 generally includes features permitting it to be mounted in a desired application, such as integral mounting feet 146. As will be appreciated by those skilled in the art, however, a wide variety of rotor configurations may be envisaged in motors that may employ the techniques outlined herein. Similarly, the present technique may be applied to a variety of motor types having different frame designs, mounting and cooling styles, and so forth.

Referring now to FIG. 11, the mounting arrangement of front bearing set or assembly 140 within the front end cap 124 is shown in greater detail. It will be appreciated that rear bearing set or assembly 142 may be similarly mounted within the rear end cap 126. In the present embodiment, bearing assembly 142 is disposed within a bearing recess 148 formed in front end cap 124 that generally defines a bearing support surface 150. A shoulder 152 may also be provided to facilitate positioning of the bearing assembly 140 within the recess. The exemplary bearing assembly 140 comprises bearing elements 154 disposed between an inner ring member 156 and an outer ring member 158 to enable relative rotational motion of these members. Although inner ring member 156 is presently illustrated as having direct contact with shaft 138, it should be noted that other elements may be disposed between these two components and that, in some embodiments, the components may be secured to one another through the various presently disclosed techniques. As described above, the bearing assembly 140 may also include seal assemblies to facilitate retention of lubricant between the inner and outer ring members.

In the presently illustrated embodiment, tapered outer sleeve 160 and tapered inner sleeve 162 cooperate with one another and with a locking member or nut 164 to secure the bearing assembly 140 within the bearing recess 148 and to the bearing support surface 150. In this embodiment, the outer sleeve 160 includes an outer surface 166 that interfaces with the bearing support surface 150, and a tapered inner surface 168. The tapered inner surface 168 interfaces with a mating tapered outer surface 170 of the inner sleeve 162, which also includes an inner surface 172 to interface with the outer ring member 158 of the bearing assembly 140. The locking member 164 interfaces with the mating sleeves 160 and 162 to draw the sleeves into and out of tight engagement with one another. More particularly, the inner sleeve 162 includes an annular inner groove 174 that defines an annular lip 176, and the outer sleeve 160 includes an inwardly threaded extension 178, which are configured to interface with various features of the nut 164 to effect assembly and disassembly of the system through rotation of the nut, as described in greater detail below. As will be appreciated, the sleeves 160 and 162 may also include various additional features not specifically illustrated with respect to these sleeves, including features illustrated with respect to sleeves 36 and 82 above, as well as other mechanical features such as keys, splines, slits, or the like.

As similarly discussed above, in some embodiments, either or both of the sleeves 160 and 162 may be a non-conductive sleeve. Because of their position between the outer circumference of the bearing assembly 140 and bearing support surface 150 of front end cap 124, the non-conductive sleeve(s) may facilitate electrical isolation of the bearing assembly 140 from the front end cap 124 and at least partially disrupt the electrical path from the shaft 138 to ground through the bearing assembly 140. To further impede the flow of current from the shaft 138 through the bearing assembly 140, the bearing support surface 150 and shoulder 152, in one embodiment, include a non-conductive coating to further effect electrical isolation of the bearing assembly from the end cap 124 and to reduce the incidence of damage to the bearing assembly caused by electrical arcing.

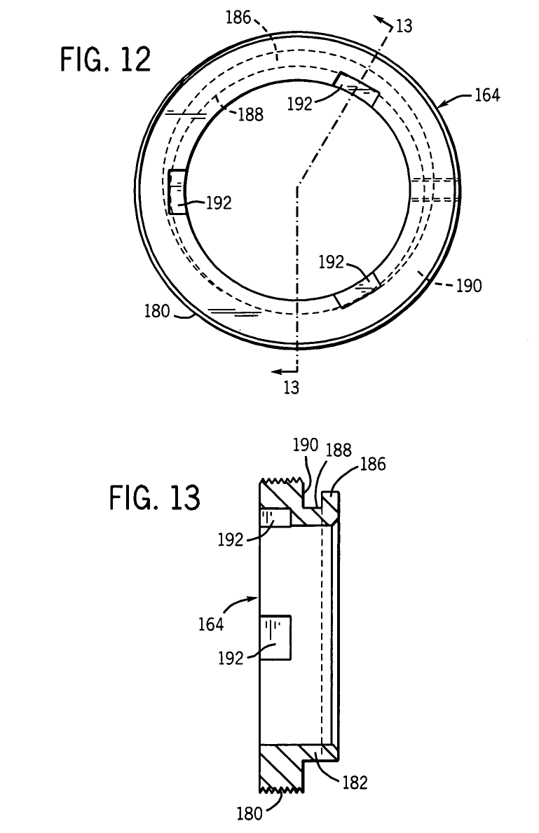

Certain features of the exemplary locking member 164 are illustrated and may be better understood with reference to FIGS. 12 and 13. As shown in the illustrated embodiment, the locking member 164 has a threaded outer surface or portion 180 designed to engage the threaded extension 178 of the outer sleeve 160. The locking member also includes an axially extending portion 182 having an eccentric radial lip or flange 186 configured to interface with the inner sleeve 162 as discussed below. The eccentric flange 186 also generally defines an external groove 188 that is concentric with respect to the general configuration of the nut 164, and particularly with respect to the exterior threaded surface of the nut.

Due to the concentricity of the groove 188 and the eccentricity of the lip or flange 186, the depth of the groove 188 or the height of the lip 186 vary circumferentially about the nut 164 with respect to one another. For instance, in one embodiment, the depth of the groove 188 varies with respect to the lip 186 from a maximum depth at a first position, to a minimum depth at a second position diametrically opposite the first position, as illustrated in FIGS. 12 and 13. Further, it should be noted that at the minimum depth, the groove 188 and the lip 186 may be substantially flush with one another in one embodiment. Other configurations, however, in which the groove 188 and lip 186 are not flush with one another, are also envisaged. It should be noted that the eccentricity of flange 186, like the eccentric aperture 58 of the nut 16, may facilitate installation and easier engagement of the nut 164 with the inner sleeve 162. Groove 188 is bounded on a side opposite radial flange 186 by an abutment face 190. Finally, tool recesses 192 or similar structures are preferably provided to permit engagement of a tool (not shown) for tightening and loosening the nut 164 in the assembly.

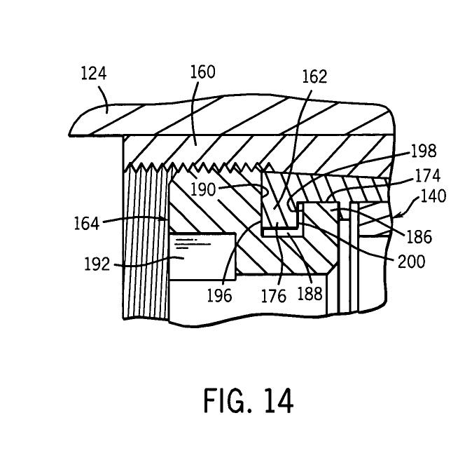

Interaction of various surfaces of the nut 164 and the sleeves 160 and 162 may be better understood with reference to the detail illustration of FIG. 14. As shown in FIG. 14, the annular groove 174 of the inner sleeve 162 is configured to receive the eccentric flange 186 of the nut 164. Similarly, the external groove 188 of the nut 164 is configured to receive the annular lip 176 of the inner sleeve 162. As the nut 164 is rotated during assembly of the system, abutment face 190 of the nut 164 contacts the distal face 196 of the inner sleeve 162 to force the inner sleeve in a first direction while drawing the outer sleeve 160 in an opposite direction, resulting in a relative increase in the maximum cross-sectional area of the sleeves and, in turn, tight engagement of the sleeves, the bearing assembly 140, and the front end cap 124. In an alternative embodiment, however, the eccentric lip 186 of the nut 164 may engage a corresponding surface of the inner sleeve 162 proximate the annular groove 174 to force the sleeves into engagement. Disassembly of the sleeves 160 and 162 may be similarly effected by counterrotation of the nut 164. Particularly, as the nut 164 is loosened, a surface 198 of the eccentric lip 186 formed on the nut engages an inner surface 200 of the annular lip 176 of the inner sleeve 162 to force the inner and outer sleeves apart from one another in a manner similar to that described above with respect to FIGS. 5 and 8.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for coupling a first member of a machine to a second member of the machine, the method comprising:
providing at least one insulating sleeve configured to be interposed between the first and second members of the machine; and
providing a locking member configured to cooperate with the at least one insulating sleeve to secure the first and second members to one another such that the at least one insulating sleeve facilitates electrical isolation of the first member from the second member.

2. The method of claim 1, wherein the at least one sleeve comprises an inner sleeve and an outer sleeve, the inner sleeve having an inner surface configured to interface with the first member and a tapered outer surface configured to interface with a tapered inner surface of the outer sleeve, and the outer sleeve having an outer surface configured to interface with the second member.

3. The method of claim 1, wherein the at least one insulating sleeve is formed of a non-conductive material.

4. The method of claim 1, wherein the at least one insulating sleeve comprises a non-conductive exterior coating.

5. The method of claim 1, wherein the first member is a shaft.

6. The method of claim 5, wherein the second member is a bearing component.

7. The method of claim 1, wherein the first member is a bearing component.

8. The method of claim 7, wherein the second member is a bearing support surface defining a bearing recess.

9. The method of claim 8, wherein the bearing recess is located in a motor housing, and the locking member is configured to be disposed within the bearing recess.

10. A method for coupling a first mechanical component to a second mechanical component, the method comprising:
removing material from a damaged surface of a first mechanical component;
assembling a tapered outer sleeve and a tapered inner sleeve between the first mechanical component and a second mechanical component, the outer and inner sleeves having tapered surfaces configured to interface with one another, one of the sleeves having a cylindrical extension presenting an annular groove forming a concentric lip, the other sleeve having a threaded extension;
assembling a locking member on the inner and outer sleeves, the locking member including a threaded section to interface with the threaded extension, and an eccentric lip defining a varying depth groove for receiving the concentric lip; and
tightening the locking member with respect to the threaded extension to draw the outer sleeve and inner sleeve into engagement between the first and second mechanical components.

11. The method of claim 10, wherein removing material comprises machining the first mechanical component to remove the damaged portion of the surface.

12. The method of claim 11, wherein the surface comprises an outer surface.

13. The method of claim 10, wherein the threaded extension is an externally threaded extension, and the inner sleeve comprises the externally threaded extension.

14. The method of claim 10, wherein the threaded extension is an internally threaded extension, and the outer sleeve comprises the internally threaded extension.

15. A method for coupling a first mechanical component to a second mechanical component, the method comprising:
disposing a first mechanical component within a bore of a second mechanical component; and
assembling tapered inner and outer sleeves within the bore between the first and second mechanical components, the inner and outer sleeves having mating tapered surfaces configured to interface with one another to facilitate coupling of the first and second mechanical components, wherein at least one of the inner or outer sleeves is configured to inhibit current flow between the first and second mechanical components.

16. The method of claim 15, wherein one of the inner or outer sleeves inlcudes an annular groove and the other sleeve includes a threaded surface.

17. The method of claim 16, comprising assembling a locking member on the inner and outer sleeves, the locking member including an eccentric lip configured to interface with the annular groove of the one sleeve, and a threaded portion configured to interface with the threaded surface of the other sleeve.

18. The method of claim 17, comprising rotating the locking member to draw the inner and outer sleeves into engagement between the first and second mechanical components.

19. The method of claim 15, wherein the inner sleeve is formed of a non-conductive material.

20. The method of claim 15, wherein the inner sleeve comprises a non-conductive coating on at least one surface of the inner sleeve.
